(19) United States
(12) Patent Application Publication
(10) Pub. No.: US 2018/0253815 A1
(43) Pub. Date: Sep. 6, 2018

(54) METHODS AND SYSTEMS FOR MODIFYING LOCATION INFORMATION OF A REQUEST

(71) Applicant: BEIJING DIDI INFINITY TECHNOLOGY AND DEVELOPMENT CO., LTD., Beijing (CN)

(72) Inventor: Bo LIU, Beijing (CN)

(73) Assignee: BEIJING DIDI INFINITY TECHNOLOGY AND DEVELOPMENT CO., LTD., Beijing (CN)

(21) Appl. No.: 15/972,314

(22) Filed: May 7, 2018

Related U.S. Application Data
(63) Continuation of application No. PCT/CN2017/082849, filed on May 3, 2017.

(30) Foreign Application Priority Data
Dec. 30, 2016 (CN) 201611257778.6

(51) Int. Cl. G06Q 50/30; H04W 4/02; G01C 21/26; G06Q 10/02

(52) U.S. Cl. CPC G06Q 50/30; G06Q 10/02; G01C 21/26; H04W 4/02

(57) ABSTRACT

The present disclosure relates to systems and methods for modifying location information of a request. The systems may perform the methods to receive, from a first user terminal associated with a service requester, at least one modification of a request for transportation service, wherein the at least one modification comprises at least one of a modified pickup-location or a modified destination; identify a service provider associated with the request for transportation service; generate updated information related to the request for transportation service based on the at least one modification of the request for transportation service; and send, to a second user terminal associated with the service provider, the updated information related to the request for transportation service.

### CROSS-REFERENCE TO RELATED APPLICATIONS

This application is a continuation of International Application No. PCT/CN2017/082849, filed on May 3, 2017, which claims priority of Chinese Patent Application No. 201611257778.6 filed on Dec. 30, 2016, the contents of which are hereby incorporated by reference in their entirety.

### TECHNICAL FIELD

The present disclosure generally relates to an online on-demand transportation service system, and more particularly, to methods and systems for modifying location information of a request.

### BACKGROUND

On-demand services, such as online ridesharing services and delivery services, have become increasingly popular because of their convenience. A service platform that provides such services may need to process a high volume of complex data and conduct a massive amount of computation to automatically process and fulfill user requests. To provide scalable and real-time services to millions of users, such a service platform may need to perform the processing and computation using pattern recognition techniques, machine learning techniques, data mining techniques, predictive analytics, user behavior analytics, cloud computing techniques, and other computational techniques.

### SUMMARY

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

The technical solution of this disclosure relates to online transportation services. Particularly, the technical solution relates to modify an origin and/or a destination of a request and send the modified origin and/or the modified destination to a service provider (e.g., a driver) through a server of an online on-demand transportation platform. It should be noted that online on-demand transportation service is a new form of service rooted only in the post-Internet era. It provides technical solutions to users and service providers that could raise only in the post-Internet era. In the pre-Internet era, when a user hails a taxi on street, the taxi request and acceptance occur only between the passenger and one taxi driver that sees the passenger. If the passenger hails a taxi through a telephone call, the service request and acceptance may occur only between the passenger and one service provider (e.g., one taxi company or agent). If the passenger wants to modify the destination, the passenger has to inform the driver of the modified destination face to face. If the passenger is unfamiliar with the modified destination, it is hard for the passenger to describe the modified destination clearly. Online transportation service, however, obtains the modified origin and/or the modified destination from the passenger and automatically send the modified origin and/or the modified destination to the driver in real-time. The online transportation service also provides navigation information related to the modified origin and/or the modified destination to the driver to navigate the driver to the modified origin and/or the modified destination. The online transportation service also provides updated cost information related to the modified origin and/or the modified destination to the driver and/or the passenger. Therefore, through the Internet, the online on-demand transportation systems may provide a much more efficient transaction platform for the users and the service providers (e.g., the drivers) that may never meet in a traditional pre-Internet transportation service system.

According to a first aspect of the present disclosure, a system may include one or more storage media and at least one processor configured to communicate with the one or more storage media. The one or more storage media may include a set of instructions. When the at least one processor executing the set of instructions, the at least one processor may be directed to perform one or more of the following operations. The at least one processor may receive at least one modification of a request for transportation service from a first user terminal associated with a service requester, wherein the at least one modification may comprise at least one of a modified pickup-location or a modified destination. The at least one processor may identify a service provider associated with the request for transportation service. The at least one processor may generate updated information related to the request for transportation service based on the at least one modification of the request for transportation service. The at least one processor may send to a second user terminal associated with the service provider, the updated information related to the request for transportation service.

In some embodiments, the updated information related to the request for transportation service may include at least one of the modified destination or the modified pick-up location.

In some embodiments, the at least one processor may determine a first location of the service provider. The at least one processor may determine a first updated route based on the first location of the service provider and the modified pick-up location, wherein the updated information may be related to the request for transportation service comprises the first updated route.

In some embodiments, the at least one processor may determine an original pick-up location of the request for transportation service. The at least one processor may determine a first distance between the original pick-up location and the first location of the service provider. The at least one processor may determine a second distance between the modified pick-up location and the location of the service provider based on the first updated route. The at least one processor may determine a difference between the first distance and the second distance. The at least one processor may compare the difference with a threshold. The at least one processor may determine a first updated cost based on the comparison, wherein the updated information may be related to the request for transportation service comprises the first updated cost.

In some embodiments, the at least one processor may determine an original destination of the request for transportation service. The at least one processor may determine a second updated route based on the modified pick-up location and the original destination, wherein the updated information may be related to the request for transportation service comprises the second updated route.

In some embodiments, the at least one processor may determine a third distance between the modified pick-up location and the original destination based on the second updated route and determine a second updated cost based on the third distance, wherein the updated information may be related to the request for transportation service comprises the second updated cost.

In some embodiments, the at least one processor may determine a third updated route based on the modified pick-up location and the modified destination, wherein the updated information may be related to the request for transportation service comprises the third updated route.

In some embodiments, the at least one processor may determine a fourth distance between the modified pick-up location and the modified destination based on the third updated route. The at least one processor may determine a third updated cost based on the fourth distance, wherein the updated information may be related to the request for transportation service comprises the third updated cost.

In some embodiments, the at least one processor may generate a determination result by determining whether the service provider has picked up a subject related to the request for transportation service. The at least one processor may generate the updated information related to the request for transportation service based on the determination result.

In some embodiments, the at least one processor may determine a second location of the service provider. The at least one processor may determine a fourth updated route based on the second location of the service provider and the modified destination, wherein the updated information may be related to the request for transportation service comprises the fourth updated route, wherein the determination results may comprise a determination that the service provider has picked up the subject related to the request for transportation service.

In some embodiments, the at least one processor may determine a fifth distance between the second location of the service provider and determine the modified destination based on the fourth updated route. The at least one processor may determine a fourth updated cost based on the fifth distance, wherein the updated information may be related to the request for transportation service comprises the fourth updated cost.

In some embodiments, the at least one processor may determine an original pick-up location of the request for transportation service. The at least one processor may determine a fifth updated route based on the original pick-up location and the modified destination, wherein the updated information may be related to the request for transportation service comprises the fifth updated route, wherein the determination result may comprise a determination that the service provider has not picked up the subject.

In some embodiments, the at least one processor may determine a sixth distance between the original pick-up location and the modified destination based on the fifth updated route. The at least one processor may determine a fifth updated cost based on the sixth distance, wherein the updated information may be related to the request for transportation service comprises the fifth updated cost.

In some embodiments, the at least one processor may determine determining timing information related to the at least one modification of the request for transportation service. The at least one processor may determine a sixth updated cost based on the timing information, wherein the updated information may be related to the request for transportation service comprises the sixth updated cost.

According to a second aspect of the present disclosure, a method may include one or more of the following operations. The at least one processor may receive at least one modification of a request for transportation service from a first user terminal associated with a service requester, wherein the at least one modification may comprise at least one of a modified pickup-location or a modified destination. The at least one processor may identify a service provider associated with the request for transportation service. The at least one processor may generate updated information related to the request for transportation service based on the at least one modification of the request for transportation service. The at least one processor may send to a second user terminal associated with the service provider, the updated information related to the request for transportation service.

According to a third aspect of the present disclosure, a non-transitory computer-readable medium may comprise executable instructions. When at least one processor executing the set of instructions, the at least one processor may be directed to perform one or more of the following operations. The at least one processor may receive at least one modification of a request for transportation service from a first user terminal associated with a service requester, wherein the at least one modification may comprise at least one of a modified pickup-location or a modified destination. The at least one processor may identify a service provider associated with the request for transportation service. The at least one processor may generate updated information related to the request for transportation service based on the at least one modification of the request for transportation service. The at least one processor may send to a second user terminal associated with the service provider, the updated information related to the request for transportation service.

### BRIEF DESCRIPTION OF THE DRAWINGS

FIG. 1 is a schematic block diagram of an exemplary online on-demand transportation service system according to some embodiments.

FIG. 2 is a schematic block diagram illustrating exemplary hardware and software components of a computing device according to some embodiments of the present disclosure.

FIG. 3 is a schematic block diagram illustrating an exemplary architecture of a processing engine according to some embodiments of the present disclosure.

FIG. 4 is a flowchart illustrating an exemplary process of generating updated information by a server according to some embodiments of the present disclosure.

FIG. 5 is a flowchart illustrating an exemplary process of generating updated route information according to some embodiments of the present disclosure.

FIG. 6 is a flowchart illustrating an exemplary process of generating updated route information according to some embodiments of the present disclosure.

FIG. 7 is a flowchart illustrating an exemplary process of generating updated cost information according to some embodiments of the present disclosure.

FIG. 8 is a flowchart illustrating an exemplary process of generating updated cost information according to some embodiments of the present disclosure.

FIG. 9 is a schematic block diagram illustrating an exemplary architecture of a user terminal associated with a service provider according to some embodiments of the present disclosure.

FIG. 10 is a flowchart illustrating an exemplary process of generating updated information by a user terminal associated with a service provider according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to modifying location information of a request, it should also be understood that this is only one exemplary embodiment. The system or method of the present disclosure may be applied to any other kind of online on-demand transportation service. For example, the system or method of the present disclosure may be applied to transportation systems of different environments including land, ocean, aerospace, or the like, or any combination thereof. The vehicle of the transportation systems may include a taxi, a private car, a hitch, a bus, a bike, an electric bicycle, a tricycle, a motorcycle, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or any combination thereof.

The term “passenger,” “requester,” “service requester,” in the present disclosure are used interchangeably to refer to an individual, an entity or a tool that may request or order a service. Also, the term “driver,” “provider,” “service provider,” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger” and “passenger terminal” may be used interchangeably, and “driver” and “driver terminal” may be used interchangeably.

The term “service request” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (Wi-Fi) positioning technology, or the like, or any combination thereof. One or more of the above positioning systems may be used interchangeably in the present disclosure.

An aspect of the present disclosure relates to online systems and methods for modifying the origin and/or the destination of a request. The online on-demand transportation service platform may generate a modified route and a modified cost based on the modified origin and/or the modified destination.

An online transportation service system may enable users to order a request for a transportation service. To modify a pickup location or destination of a request using existing online transportation service systems, a passenger may have to communicate with the driver face to face or by telephone. This may have detrimental effects to user experience. Accordingly, it is desirable to provide new mechanisms for modifying location information of requests for transportation services to improve user experience.

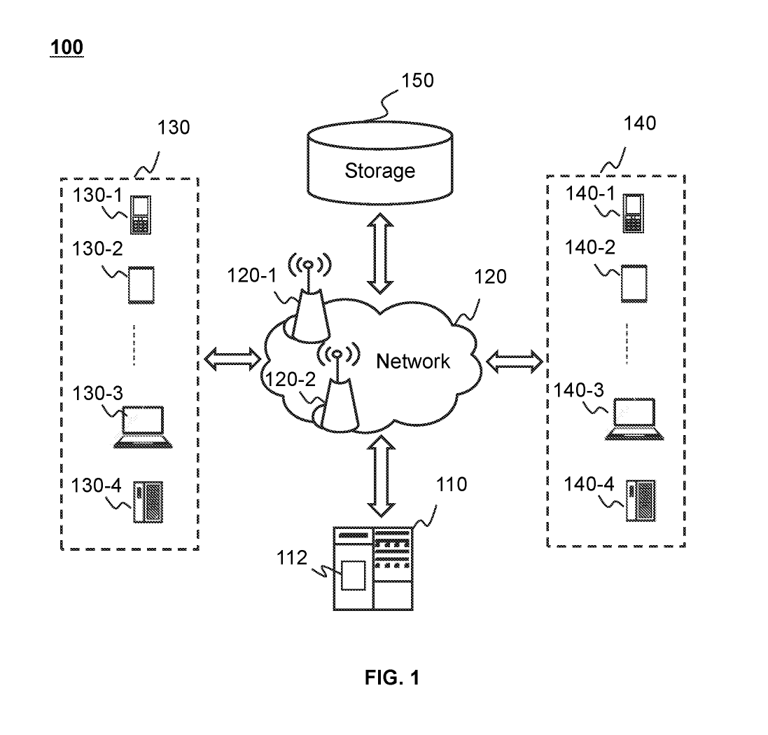

FIG. 1 is a schematic block diagram of an exemplary online on-demand transportation service system 100 according to some embodiments of the present disclosure. In some embodiments, the system 100 may be a system for transportation services such as taxi hailing, chauffeur service, express car, carpool, bus service, driver hire and shuttle service. The system 100 may include a server 110, a network 120, one or more user terminals (e.g., one or more requester terminals 130, provider terminals 140), and a storage 150. The server 110 may include a processing engine 112.

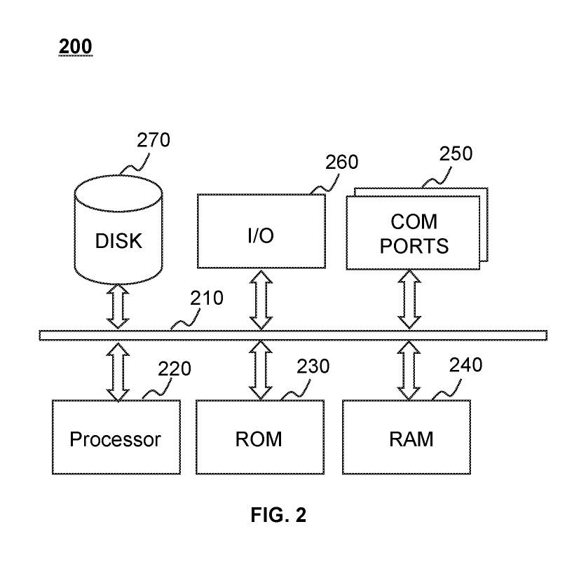

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the requester terminal 130, the provider terminal 140, and/or the storage 150 via the network 120. As another example, the server 110 may be directly connected to the requester terminal 130, the provider terminal 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may determine updated information based on the modified origin and/or the modified destination obtained from the requester terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the system 100 (e.g., the server 110, the requester terminal 130, the provider terminal 140, and the storage 150) may send information and/or data to other component(s) in the system 100 via the network 120. For example, the server 110 may obtain/acquire service request from the requester terminal 130 via the network 120. In some embodiments, the network 120 may be any type of wired or wireless network, or combination thereof. Merely by way of example, the network 130 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the system 100 may be connected to the network 120 to exchange data and/or information.

In some embodiments, the requester terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google™ Glass, an Oculus Rift™, a Hololens™, a Gear VR™, etc. In some embodiments, built-in device in the motor vehicle 130-4 may include an onboard computer, an onboard television, etc. In some embodiments, the requester terminal 130 may be a device with positioning technology for locating the position of the service requester and/or the requester terminal 130.

In some embodiments, the provider terminal 140 may be similar to, or same as the requester terminal 130. In some embodiments, the provider terminal 130 may be a device with positioning technology for locating the position of the service requester and/or the requester terminal 130. In some embodiments, the provider terminal 140 may be a device with positioning technology for locating the position of the service provider and/or the provider terminal 140. In some embodiments, the requester terminal 130 and/or the provider terminal 140 may communicate with other positioning device to determine the position of the service requester, the requester terminal 130, the service provider, and/or the provider terminal 140. In some embodiments, the requester terminal 130 and/or the provider terminal 140 may send positioning information to the server 110.

In some embodiments, the requester terminal 130 may install an application for sending out a transportation service request. Through the application, the requester terminal 130 may establish connection and communicate with the server 110. In some embodiments, the provider terminal 140 may install an application for accepting a transportation service request. Through the application, the provider terminal 140 may establish connection and communicate with the server 110.

In some embodiments, a service requester may request a transportation service using the requester terminal 130. In some embodiments, a service provider may provide a transportation service to a service requester by accepting a request using the provider terminal 140.

The storage 150 may store data and/or instructions. In some embodiments, the storage 150 may store data obtained from the requester terminal 130 and/or the provider terminal 140. In some embodiments, the storage 150 may store data and/or instructions that the server 110 may execute or use to perform exemplary methods described in the present disclosure. In some embodiments, storage 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components in the system 100 (e.g., the server 110, the requester terminal 130, the provider terminal 140, etc.). One or more components in the system 100 may access the data or instructions stored in the storage 150 via the network 120. In some embodiments, the storage 150 may be directly connected to or communicate with one or more components in the system 100 (e.g., the server 110, the requester terminal 130, the provider terminal 140, etc.). In some embodiments, the storage 150 may be part of the server 110.

In some embodiments, one or more components in the system 100 (e.g., the server 110, the requester terminal 130, the provider terminal 140, etc.) may have a permission to access the storage 150. In some embodiments, one or more components in the system 100 may read and/or modify information relating to the service requester, the service provider, and/or the public when one or more conditions are met. For example, the server 110 may read and/or modify one or more users' information after a service. As another example, the provider terminal 140 may access information relating to the service requester when receiving a service request from the requester terminal 130, but the provider terminal 140 may not modify the relevant information of the service requester.

FIG. 2 is a schematic diagram illustrating exemplary hardware and software components of a computing device 200 on which the server 110, the requester terminal 130, and/or the provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general purpose computer or a special purpose computer, both may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components therein such as user interface elements 280. The computing device 200 may also receive programming and data via network communications.

Merely for illustration, only one processor is described in the computing device 200. However, it should be note that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two different processors jointly or separately in the computing device 200 (e.g., the first processor executes step A and the second processor executes step B, or the first and second processors jointly execute steps A and B).

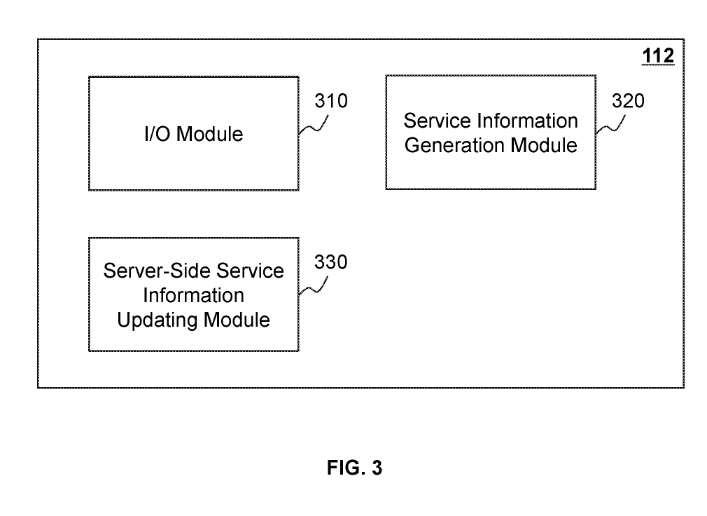

FIG. 3 is a schematic block diagram illustrating an example of the processing engine 112 according to some embodiments of the present disclosure. As illustrated, the processing engine 112 may include an I/O module 310, a service information generation module 320, and a server-side service information updating module 330.

The I/O module 310 may be configured to receive at least one modification to a request for transportation service from a first user terminal associated with a service requester. The first user terminal may be and/or include any user terminal as described in connection with FIG. 1, such as a requester terminal 130 of FIG. 1. In some embodiments, the transportation service may be a service of taking a subject from one place to another location using a vehicle. The subject may include passengers and/or goods. For example, the transportation service may be a taxi service or a delivery service. The vehicle may include a taxi, a private car, a hitch, a bus, a bike, an electric bicycle, a tricycle, a motorcycle, a train, a bullet train, a high speed rail, a subway, a vessel, an aircraft, a spaceship, a hot-air balloon, a driverless vehicle, or the like, or any combination thereof. In some embodiments, the request may include an original pickup location and an original destination. In some embodiments, the modification may include a modified pickup location of the request and/or a modified destination of the request. In some embodiments, the I/O module 310 may receive the at least one modification before or after the subject is picked up. Alternatively or additionally, the I/O module 310 can receive the modification when the transportation is rendered.

The service information generation module 320 may be configured to identify a service provider associated with the request for transportation service. In some embodiments, the service provider may be a user that accepts the request for transportation service. In some embodiments, the service provider may use a second user terminal to communicate with the server 110 via the network 120. In some embodiments, the second user terminal may be a provider terminal 140 of FIG. 1.

The server-side service information updating module 330 may be configured to generate updated information based on the at least one modification. In some embodiments, the updated information may include the at least one modification, updated route information, updated cost information, any other information related to the service request and/or the modification, or the like, or any combination thereof. In some embodiments, the updated route information may include a pickup updated route and/or a service updated route. The pickup updated route may include a first updated route from a first location of the service provider to the modified pickup location. The first location of the service provider may include, for example, the location of the service provider when the I/O module 310 receives the at least one modification before the service provider picks up the subject. The service updated route may include at least one of a second updated route from the modified pickup location to the original destination, a third updated route from the modified pickup location to the modified destination, a fourth updated route from the second location of the service provider to the modified destination or a fifth updated route from the original pickup location to the modified destination. The second location of the service provider may refer to include, for example, the location of the service provider when the I/O module 310 receives the at least one modification after the service provider picks up the subject.

The updated cost information may include one or more surcharges, fees, and/or any other cost related to the modification to the request for transportation service. In some embodiments, the server-side service information updating module 330 may determine the updated cost information based on the updated route information. In some embodiments, the updated cost information may include a first updated cost and/or a second updated cost. The server-side service information updating module 330 may determine the first updated cost based on the pickup updated route. The server-side service information updating module 330 may determine the second updated cost based on the service updated route.

In some embodiments, the I/O module 310 may be further configured to send the updated information to the first user terminal and/or the second user terminal.

The modules 310, 320, and/or 330 may include hardware circuits of all or part of the processing engine 112. The modules may also be implemented as an application or set of instructions read and executed by the processing engine. Further, the modules may be a combination of the hardware circuits and the application/instructions. For example, the modules may be the part of the processing engine 112 when the processing engine is executing the application/set of instructions

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the I/O module 310 may be integrated in the service information generation module 320 as a single module that may both obtain the request for transportation service and identify the service provider. As another example, the I/O module 310 may be divided into an input unit that may receive the at least one modification and an output unit that may send the updated information.

It should be noted that the processing engine 112 illustrated in FIG. 3 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. In some embodiments, the processing engine 112 may further include a storage module (not shown in FIG. 3) configured to store data and/or instructions.

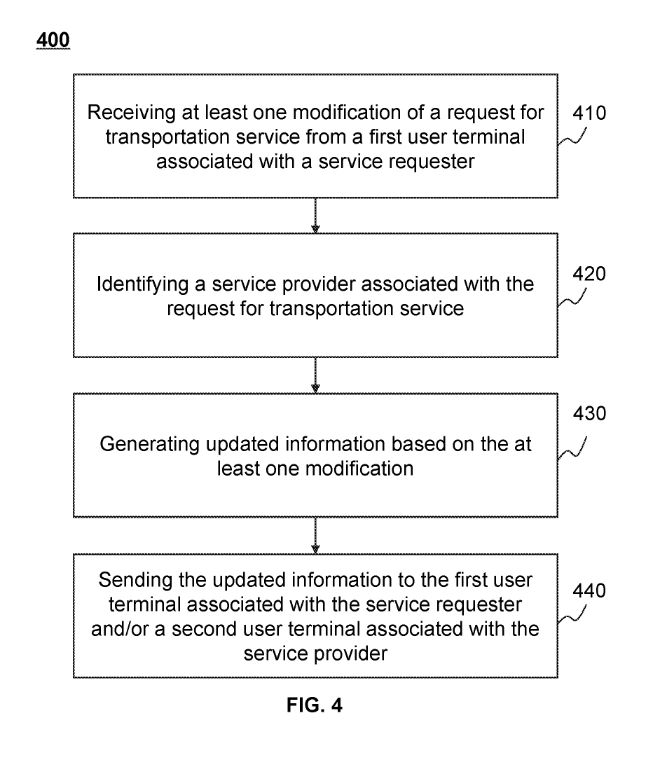

FIG. 4 is a flowchart illustrating an exemplary process of generating updated service information by a server according to some embodiments of the present disclosure. In some embodiments, the process 400 may be implemented in the system 100 illustrated in FIG. 1. For example, the process 400 may be stored in the storage 150 and/or the storage device (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more modules in the processing engine 112 illustrated in FIG. 3).

In some embodiments, a service requester may send a request for transportation service to an online on-demand transportation service platform (e.g., the server 110) using a first user terminal (e.g., the requester terminal 130). After receiving the request, the online on-demand transportation service platform (e.g., the server 110) may allocate the request to a service provider. The service provider may accept the request using a second user terminal (e.g., the provider terminal 140). If the service requester modifies the pickup location of the request and/or the destination of the request and send the modified pickup location and/or the modified destination to the server 110 using the first user terminal, the processing engine 112 in the server 110 may perform the process 400 and generate updated information.

In step 410, the I/O module 310 may receive at least one modification to a request for transportation service of a subject from a first user terminal associated with a service requester. The modification may include any change to the request. For example, the modification may include a modified pickup location and/or a modified destination. In some embodiments, the service requester may use the first user terminal to request or order a transportation service. In some embodiments, the service requester may use the first user terminal to modify the pickup location of the request and/or the destination of the request. The first user terminal may send the modified pickup location and/or the modified destination to the server 110. The modification can be made and/or sent before or after the subject is picked up. For example, before the subject is picked up, the service requester may use the first user terminal to modify the pickup location and/or the destination and send the modified pickup location and/or the modified destination to the server 110. As another example, after the subject is picked up, the service requester may use the first user terminal to modify the destination and send the modified destination to the server 110. In some embodiments, the first user terminal may be a requester terminal 130 of FIG. 1.

In step 420, the service information generation module 320 may identify a service provider associated with the request for transportation service. The service provider associated with the request for transportation service may be and/or include a user that accepts the request for transportation service, a user to which the service request has been allocated, and/or any other user that can be regarded as being associated with the request for transportation. In some embodiments, the service provider can be associated with the request for transportation service by the service information generation module 320 and/or any other device upon receiving an acceptance of the request from a user terminal associated with the service provider and/or allocating the request to the service provider. The service provider and the request for transportation service can be associated by storing information related to the service provider (e.g., identifying information about the service provider and/or a user terminal associated with the service provider) in association with information about the request.

The service provider may be identified, for example, by retrieving information related to the request for transportation service. In some embodiments, the service information generation module 320 can identify the service provider by identifying a user terminal associated with the service provider. The service provider and/or the user terminal associated with the service provider may be identified using a user identification, a user account, an identification of the user terminal, and/or any other identifying information that can be used to identify the service provider and/or the user terminal associated with the service provider.

In step 430, the server-side service information updating module 330 may generate updated information based on the at least one modification. In some embodiments, the updated information may include the at least one modification, updated route information, updated cost information, any other information related to the request and/or the modification, or the like, or any combination thereof.

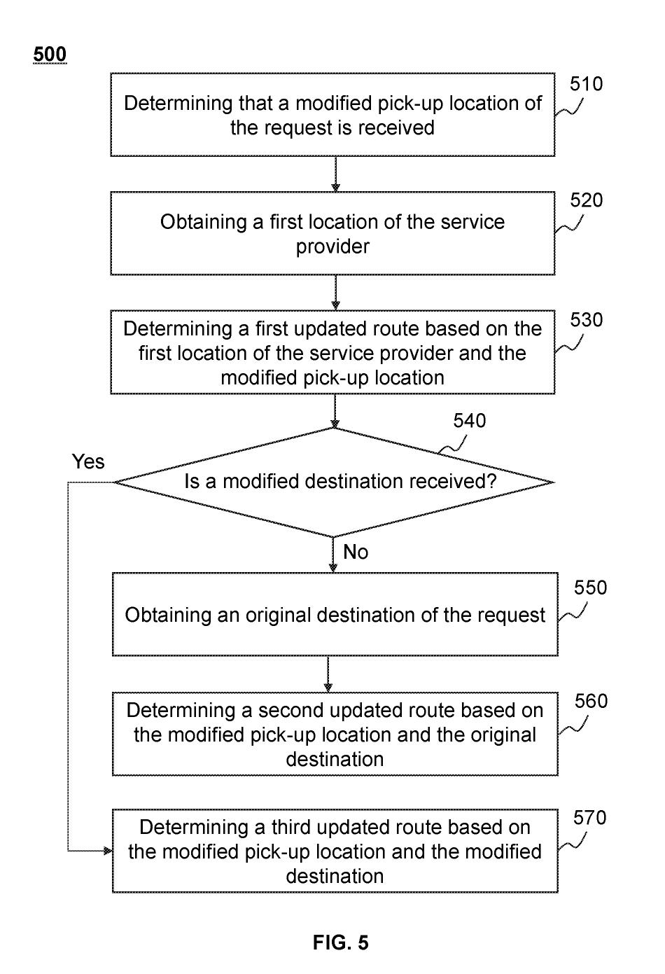

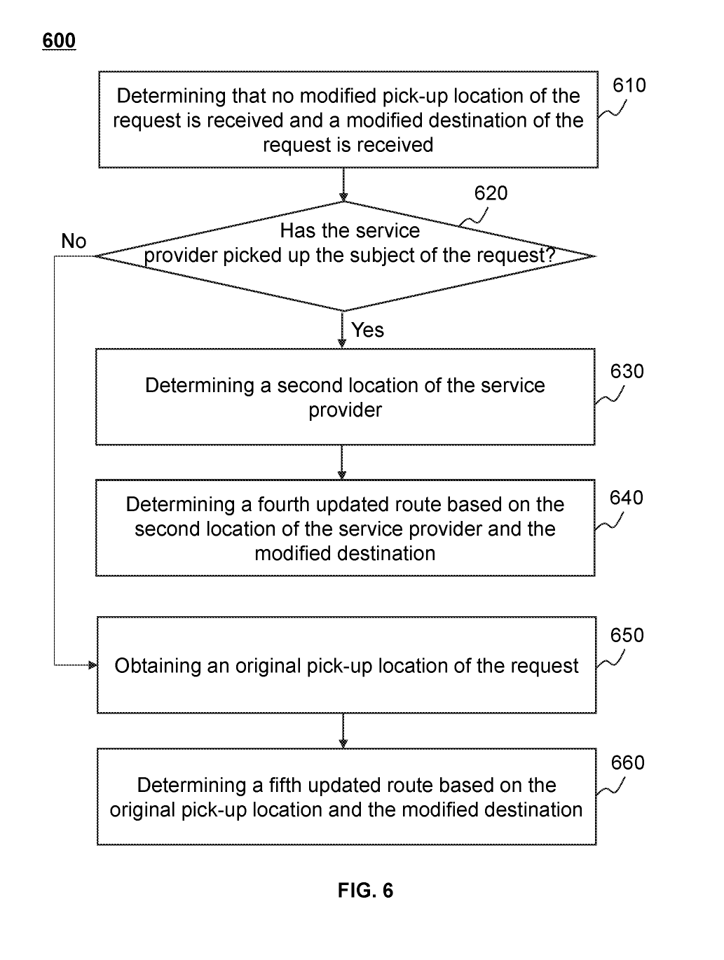

In some embodiments, the updated route information may include one or more updated routes. Each of the updated routes may be determined based on one or more of the modified pickup location, the modified destination, an original pickup location related to the request for transportation service, an original destination related to the transportation service, one or more locations of the service provider associated with the request for transportation service, and/or any other information related to the request for transpiration service and/or the modification. In some embodiments, the updated routes may be generated by performing one or more operations described in connection with FIGS. 5-6 below.

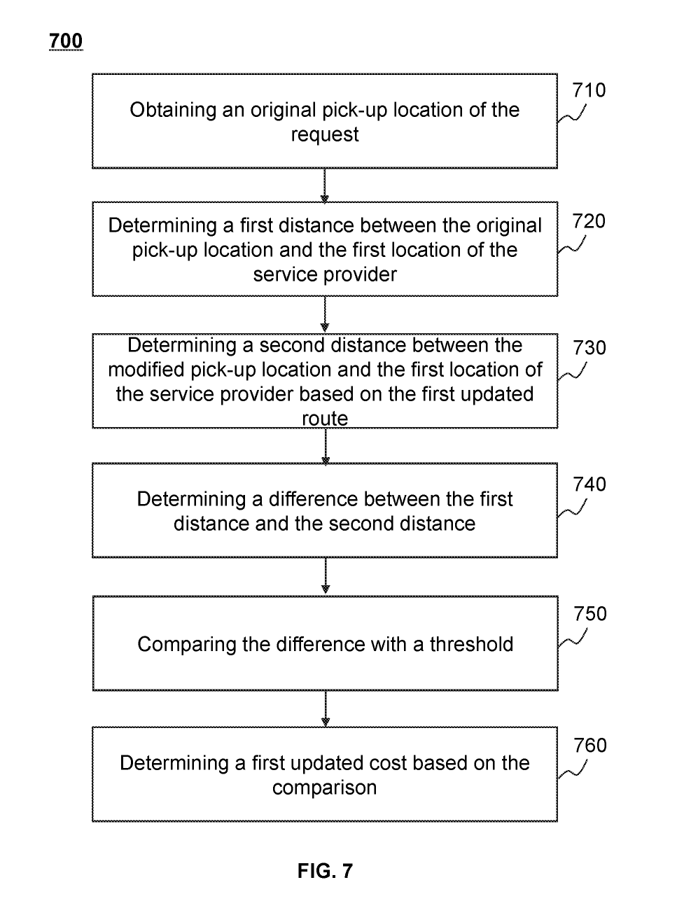

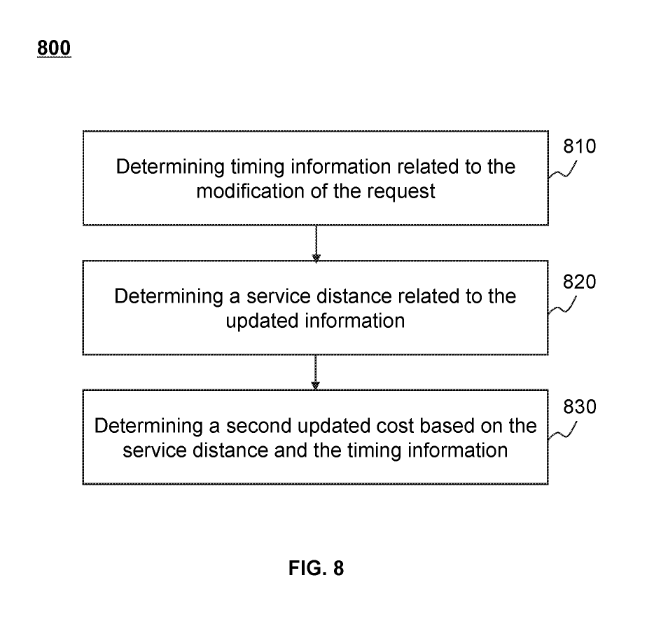

The updated cost information may include one or more surcharges, fees, and/or any other cost related to the modification to the request for transportation service. In some embodiments, the server-side service information updating module 330 may determine the updated cost information based on the updated route information. In some embodiments, the updated cost information may include one or more updated costs. Each of the updated costs may be determined based on one or more of the pickup updated route, service updated route, timing information, and/or any other information related to the request for transportation service and/or the modification. In some embodiments, the updated costs may be generated by performing one or more operations described in connection with FIGS. 7-8 below.

In step 440, the I/O module 310 may send the updated information to the first user terminal associated with the service requester and/or a second user terminal associated with the service provider. The updated information may be sent via any suitable network, such as the network 120 of FIG. 1. In some embodiments, the I/O module 310 can also send, to the first user terminal and/or the second user terminal, information and/or data that can be used to present the updated information, such as data for presenting one or more user interfaces.

FIG. 5 is a flowchart illustrating an exemplary process of generating updated route information according to some embodiments of the present disclosure. In some embodiments, the process 500 may be implemented in the system 100 illustrated in FIG. 1. For example, the process 500 may be stored in the storage 150 and/or the storage device (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more modules in the processing engine 112 illustrated in FIG. 3). In some embodiments, the server-side service information updating module 330 may generate the updated information in step 430 of the process 400 by performing the process 500.

In step 510, the server-side service information updating module 330 may determine a modified pickup location of a request. The modified pickup location may be determined based on one or more modifications to the request. In some embodiments, the modified pickup location and/or the modification can be received via the I/O module 310.

In step 520, the server-side service information updating module 330 may obtain a first location of the service provider. For example, the server-side service information updating module 330 can determine a location of the service provider at a first time instant as the first location of the service provider. The first time instant may correspond to the receiving of the modification to the request (e.g., by the I/O module 310).

In some embodiments, the server-side service information updating module 330 can determine the first time instant and can then determine a location of the service provider at the first time instant as the first location.

In some embodiments, a user terminal associated with the service provider may determine location information of the service provider using suitable positioning technology. The location information may include the first location or any information that can be used to identify the first location (e.g., one or more locations of the service provider over time). The user terminal may send the location information of the service provider to the server 110 in real-time, substantially real time, and/or any other manner via the network 120. The service information generation module 320 may receive the location information of the service provider from the second user terminal via the network 120. The service information generation module 320 can obtain the first location based on the location information (e.g., by extracting the first location from the location information, determining the first location based on one or more other locations of the service provider and/or the first time instant).

In some embodiments, the server-side service information updating module 330 may send a request for the first location of the service provider to the second user terminal based on the determination in step 510. The second user terminal may send the first location of the service provider to the service information generation module 320 in response to receiving the request for the first location of the service provider.

In step 530, the server-side service information updating module 330 may determine a first updated route based on the first location of the service provider and the modified pickup location. The first updated route may be and/or include any route between the first location and the modified pickup location.

In some embodiments, the server-side service information updating module 330 can also generate first navigation information. The first navigation information can include the first updated route, one or more driving directions, mapping data, and/or any other information that can be used by the service provider to drive to the modified pickup location. For example, the server-side service information updating module 330 may determine the first navigation information based on the modified pickup location and the first location of the service provider if the modified pickup location is different from the original location and the first location of the service provider is different from a location that the service provider receive the original pickup location of a request. In some embodiments, the I/O module 310 may receive the original pickup location earlier than the modified pickup location. The I/O module 310 may send the first navigation instruction to the second user terminal for navigating the service provider to the modified pickup location.

In step 540, the server-side service information updating module 330 may determine whether a modified destination is received by the I/O module 310. In response to determining that a modified destination is not received by the I/O module 310, process 500 may proceed to step 550. In step 550, the server-side service information updating module 330 may obtain an original destination of the request.

In step 560, the server-side service information updating module 330 may determine a second updated route based on the modified pickup location and the original destination. The second updated route may include any route between the modified pickup location and the original destination.

In some embodiments, in response to determining that a modified destination is received by the I/O module 310, process 500 may proceed to step 570. In step 570, the server-side service information updating module 330 may determine a third updated route based on the modified pickup location and the modified destination. The third updated route may include any route between the pickup location and the modified destination.

In some embodiments, the I/O module 310 may receive a modified pickup location and the server-side service information updating module 330 may determine a first updated route from the first location of the service provider to the modified pickup location and a second updated route from the modified pickup location to the original destination (e.g., the server-side service information updating module 330 may perform steps 510, 520, 530, 540, 550, and 560).

In some embodiments, the I/O module 310 may receive a modified pickup location and a modified destination. The server-side service information updating module 330 may determine a first updated route from the first location of the service provider to the modified pickup location and a third updated route from the modified pickup location to the modified destination (e.g., the server-side service information updating module 330 may perform steps 510, 520, 530, 540, and 570).

FIG. 6 is a flowchart illustrating an exemplary process of generating updated route information according to some embodiments of the present disclosure. In some embodiments, the process 600 may be implemented in the system 100 illustrated in FIG. 1. For example, the process 600 may be stored in the storage 150 and/or the storage device (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more modules in the processing engine 112 illustrated in FIG. 3). In some embodiments, the process 600 may generate the updated information in step 430 of the process 400.

In step 610, the server-side service information updating module 330 may determine that no modified pickup location of the request is received by the I/O module 310 and a modified destination of the request is received by the I/O module 310. The modified destination may be determined based on one or more modifications to the request. In some embodiments, the modified destination and/or the modification can be received via the I/O module 310.

In step 620, the server-side service information updating module 330 may determine whether the service provider has picked up the subject of the request based on the determination in step 610. In response to determining that the service provider has picked up the subject of the request, the process 500 may proceed to step 630.

In step 630, the server-side service information updating module 330 may determine a second location of the service provider. For example, the server-side service information updating module 330 can determine a location of the service provider at a second time instant as the second location of the service provider. The second time instant may correspond to the receiving of the modification to the request (e.g., by the I/O module 310) after the service provider picks up the subject.

In some embodiments, the server-side service information updating module 330 can determine the second time instant and can then determine a location of the service provider at the second time instant as the second location.

In some embodiments, a user terminal associated with the service provider may determine location information of the service provider using suitable positioning technology. The location information may include the second location or any information that can be used to identify the second location (e.g., one or more locations of the service provider over time). The user terminal may send the location information of the service provider to the server 110 in real-time, substantially real time, and/or any other manner via the network 120. The service information generation module 320 may receive the location information of the service provider from the second user terminal via the network 120. The server-side service information updating module 330 can obtain the second location based on the location information (e.g., by extracting the second location from the location information, determine the second location based on one or more other locations of the service provider and/or the second time instant).

In some embodiments, the server-side service information updating module 330 may send a request for the second location of the service provider to the second user terminal based on the determination that the service provider has picked up the subject of the request. The second user terminal may send the second location of the service provider to the service information generation module 320 in response to receiving the request for the second location of the service provider.

In step 640, the server-side service information updating module 330 may determine a fourth updated route based on the second location of the service provide and the modified destination. The fourth updated route may include any route between the second location and the modified destination.

In some embodiments, in response to determining that the service provide has not picked up the subject of the request, the process 500 may proceed to step 650.

In step 650, the service information generation module 320 may obtain an original pickup location of the request.

In step 660, the server-side service information updating module 330 may determine a fifth updated route based on the original pickup location and the modified destination. The fifth updated route may include any route between the original pickup location and the modified destination.

In some embodiments, the I/O module 310 may receive a modified destination after the service provider picks up the subject and the server-side service information updating module 330 may determine a fourth updated route from the second location of the service provider to the modified destination (e.g., the server-side service information updating module 330 may perform steps 610, 620, 630, and 640).

In some embodiments, the I/O module 310 may receive a modified destination before the service provider picks up the subject and the server-side service information updating module 330 may determine a fifth updated route from the original pickup location to the modified destination (e.g., the server-side service information updating module 330 may perform steps 610, 620, 650, and 660).

In some embodiments in which the modified pickup location is different from the original pickup location and the modified destination is different from the modified destination, the server-side service information updating module 330 may determine second navigation information based on one or more of the modified pickup location, the modified destination, an original pickup location related to the request for transportation service, an original destination related to the transportation service, or the second location of the service provider. The I/O module 310 may send the second navigation instruction to the second user terminal to navigate the service provider to the modified destination and/or the original destination. The service provider may not need to input the modified pickup location and/or the modified destination in the second user terminal to generate the second navigation instruction, which improves the efficiency and the user experience.

In some embodiments, if the I/O module 310 receives the modified pickup location and the modified destination before the service provider picks up the subject, the server-side service information updating module 330 may determine the first navigation information based on the first location of the service provider and the modified pickup location, and determine the second navigation information based on the modified pickup location and the modified destination. The I/O module 310 may send the first navigation information and the second navigation information to the second user terminal. The second user terminal may present the first navigation information when the service provider drives to the modified pickup location. The second user terminal can also present the second navigation instruction when the service provider drives to the modified destination.

In some embodiments, if the I/O muddle 310 receives the modified destination after the service provider picks up the subject, the server-side service information updating module 330 may determine the second navigation information based on the modified destination and the second location of the service provider.

In some embodiments, if the I/O muddle 310 receives the modified destination before the service provider picks up the subject, the server-side service information updating module 330 may determine the second navigation information based on the modified destination and the original pickup location.

In some embodiments, if the I/O module 310 receives the modified pickup location before the service provider picks up the subject, the server-side service information updating module 330 may determine the first navigation information based on the modified pickup location and the first location of the service provider, and determine the second navigation information based on the modified pickup location and the original destination. The I/O module 310 may send the first navigation information and the second navigation information to the second user terminal. The second user terminal may present the first navigation information when the service provider drives to the modified pickup location to pick up the subject. The second user terminal can also present the first navigation information when the service provider drives to the original destination.

In some embodiments, the second navigation information may include the second updated route, the third updated route, the fourth updated route and the fifth updated route.

FIG. 7 is a flowchart illustrating an exemplary process of generating updated cost information according to some embodiments of the present disclosure. In some embodiments, the process 700 may be implemented in the system 100 illustrated in FIG. 1. For example, the process 700 may be stored in the storage 150 and/or the storage device (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more modules in the processing engine 112 illustrated in FIG. 3). In some embodiments, the process 700 may generate the updated information in step 430 of the process 400. In some embodiments, the process 700 may generate a first updated cost based on the pickup updated route (e.g., the first updated route from the first location of the service provider to the modified pickup location). In some embodiments, the server-side service information updating module 330 may perform the process 700 after step 530 in the process 500.

In step 710, the server-side service information updating module 330 may obtain an original pickup location of the request.

In step 720, the server-side service information updating module 330 may determine a first distance between the first location of the service provider and the original pickup location. In some embodiments, the distance between two locations in the present disclosure may refer to a length of a route between the two locations other than a length of a line segment between the two locations.

In step 730, the server-side service information updating module 330 may determine a second distance between the modified pickup location and the first location of the service provider based on the first updated route.

In step 740, the server-side service information updating module 330 may determine a difference between the first distance and the second distance. In some embodiments, the server-side service information updating module 330 may determine the difference by subtracting the first distance from the second distance. In some embodiments, the server-side service information updating module 330 may determine the difference by subtracting the second distance from the first distance.

In step 750, the server-side service information updating module 330 may compare the difference with a threshold (e.g., 1 kilometer). The threshold may be greater than or equal to 0. In some embodiments, the threshold may be default settings of the system 100 (e.g., 1 kilometer), or may be adjustable depending on different situations. For example, in a traffic peak period (e.g., 7:00 am-9:00 am), the server-side service information updating module 330 may determine a relative small threshold (e.g., 1 kilometer). In an idle period (e.g., 10:00 am-12:00 am), the server-side service information updating module 330 may determine a relative larger threshold (e.g., 3 kilometer).

In some embodiments, for the condition that the server-side service information updating module 330 determines the difference by subtracting the first distance from the second distance, the server-side service information updating module 330 may determine whether the difference is greater than the threshold. For the condition that the server-side service information updating module 330 determines the difference by subtracting the second distance from the first distance, the server-side service information updating module 330 may determine whether the difference is less than 0 and whether the absolute value of the difference is greater than the threshold.

In step 760, the server-side service information updating module 330 may determine a first updated cost based on the comparison. For example, the first updated cost may be determine based on whether the difference is greater than the threshold or less than 0.

In some embodiments, the server-side service information updating module 330 may determine the first updated cost based on the difference. In some embodiments, the server-side service information updating module 330 may determine that the first cost may vary with the difference. For example, in some embodiments in which the server-side service information updating module 330 determines the difference by subtracting the first distance from the second distance, the server-side service information updating module 330 may determine that the first updated cost is proportional to the difference. In some embodiments, the server-side service information updating module 330 may determine that the first cost is a constant. For example, in some embodiments in which the server-side service information updating module 330 determines the difference by subtracting the first distance from the second distance, if the server-side service information updating module 330 determines that the difference is greater than the threshold, the server-side service information updating module 330 may determine that the first updated cost is a particular amount (e.g., 1 dollar).

In some embodiments, the server-side service information updating module 330 may perform step 730 before step 710 or step 720. In some embodiments, the server-side service information updating module 330 may perform step 730 and step 710 at the same time. In some embodiments, the server-side service information updating module 330 may perform step 730 and step 720 at the same time.

FIG. 8 is a flowchart illustrating an exemplary process of generating updated cost information according to some embodiments of the present disclosure. In some embodiments, the process 800 may be implemented in the system 100 illustrated in FIG. 1. For example, the process 800 may be stored in the storage 150 and/or the storage device (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more modules in the processing engine 112 illustrated in FIG. 3). In some embodiments, the process 800 may generate the updated information in step 430 of the process 400. In some embodiments, the process 800 may generate a second updated cost based on the service updated route (e.g., the second updated route, the third updated route, the fourth updated route or the fifth updated route). In some embodiments, the service information generation module 320 may perform the process 800 after step 560 or step 570 in the process 500. In some embodiments, the service information generation module 320 may perform the process 800 after step 640 or step 660 in the process 600.

In step 810, the server-side service information updating module 330 may determine timing information related to the modification of the request. The timing information may refer to a rule of determining a cost of the transportation service. The timing information may include a unit distance cost and/or a time coefficient. The unit distance cost may include a first unit distance cost per kilometer, a second unit distance cost for a first section of distance, a third unit distance cost per kilometer for a second section of distance, etc. For example, the server-side service information updating module 330 may determine that the unit distance cost for each section of distance is same. For instance, the server-side service information updating module 330 may determine that the unit distance cost for is 2 dollars per kilometer. As another example, the server-side service information updating module 330 may determine that the unit distance costs for different sections of distance are different.

In some embodiments, the time coefficient may be adjustable depending on different time periods. For example, the I/O module 310 receives the at least one modification in a traffic peak period (e.g., 7:00 am-9:00 am), the server-side service information updating module 330 may determine a relative large time coefficient (e.g., 2). The I/O module 310 receives the at least one modification in an idle period (e.g., 10:00 am-12:00 am), the server-side service information updating module 330 may determine a relative small time coefficient (e.g., 1).

In step 820, the server-side service information updating module 330 may determine a service distance related to the updated route information. In some embodiments, the server-side service information updating module 330 may determine the service distance based on the service updated route. In some embodiments, the service distance may include at least one of a third distance of the second updated route, a fourth distance of the third updated route, a fifth distance of the fourth updated route or a sixth distance of the fifth updated route.

In step 830, the server-side service information updating module 330 may determine a second updated cost based on the service distance and the timing information. In some embodiments, the server-side service information updating module 330 may determine the second updated cost based on the service distance and the unit distance cost. For example, the server-side service information updating module 330 may determine the second updated cost based on Equation (1) below:

C₂=Cᵤ₁×┌D_{service}┐, (1)

wherein C₂ may refer to the second updated cost; Cᵤ₁ may refer to a first unit distance cost per kilometer; D_{service} may refer to the service distance; ┌ ┐ may refer to an operation of rounding up a decimal, and the operation of rounding up a decimal may refer to an operation of changing a decimal to an integer by adding 1 to the integer part of the decimal, for example, ┌4.1┐=5, ┌4.8┐=5, ┌5┐=5.

As another example, the server-side service information updating module 330 may determine the second updated cost based on Equation (2) below:

$${C}_{2} = \{ \begin{matrix} {C}_{u 2} , & {D}_{service} \leq 4 kilometers \\ {C}_{u 2} + {C}_{u 3} \times ⌈ {D}_{service} - 4 ⌉ , & {D}_{service} > 4 kilometers\end{matrix} , \qquad ( 2 )$$

wherein Cᵤ₂ may refer to a second unit distance cost for a first section of distance; and Cᵤ₃ may refer to a third unit distance cost per kilometer for a second section of distance.

In some embodiments, the server-side service information updating module 330 may determine a second updated cost based on the service distance, the time coefficient, and the unit distance cost. For example, the server-side service information updating module 330 may determine the second updated cost based on Equation (3) below:

C₂=T×C₂′, (3)

wherein T may refer to the time coefficient; and C₂′ may refer to a cost determined based on the unit distance cost.

For example, the I/O module 310 may receive a modified pickup location of Beijing University of a request and a modified destination of Renmin University of the request at 8:00 am, the server-side service information updating module 330 may determine an updated route from Beijing University to Renmin University and determine that the distance of the updated route is 3.5 kilometers. The server-side service information updating module 330 may determine that the unit distance cost is 2 dollars per kilometers and the time coefficient at 8:00 am is 2. The server-side service information updating module 330 may determine the second updated cost as 16 dollars based on Equation (1) and Equation (3).

It should be noted that the above description about the process 800 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. In some embodiments, step 810 and step 820 may be performed in any order.

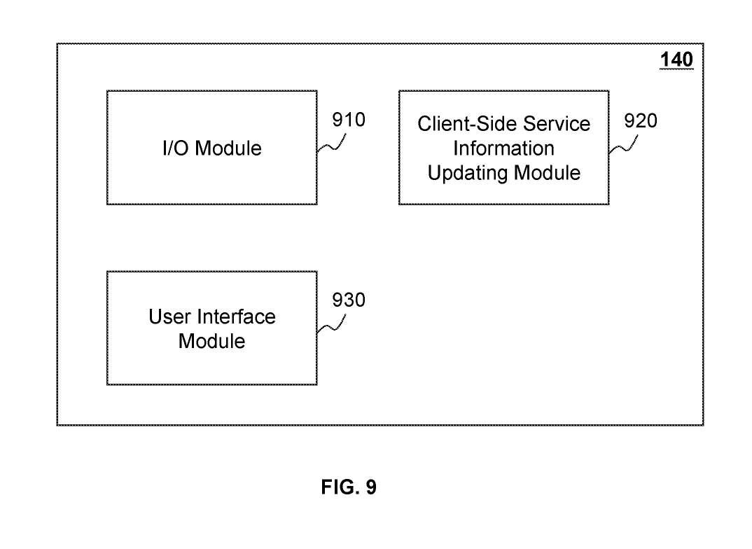

FIG. 9 is a schematic block diagram illustrating an exemplary architecture of a user terminal associated with a service provider according to some embodiments of the present disclosure. In some embodiments, the user terminal may be the provider terminal 140. In some embodiments, the updated information may be generated by the second user terminal. As illustrated, the user terminal may include an I/O module 910, a client-side service information updating module 920, and a user interface module 930.

The I/O module 910 may be configured to receive at least one modification of a request for transportation service of a subject from an online on-demand transportation service platform. The online on-demand transportation service platform may be implemented using the server 110. In some embodiments, the first user terminal associated with a service requester (e.g., the requester terminal 130) may install an application for sending out a transportation service request. Through the application, the first user terminal may establish connection and communicate with the server 110. Through the application, the service requester may modify the pickup location of the request and/or the destination of the request and send the modified pickup location and/or the modified destination to the server 110. In some embodiments, the second user terminal may install an application for accepting a transportation service request. Through the application, the second user terminal may establish connection and communicate with the server 110 and receive the modified pickup location and/or the modified destination from the server 110.

Client-side service information updating module 920 may be configured to determine updated information of the request based on the at least one modification. In some embodiments, the I/O module 910 may be further configured to send the updated information to a first user terminal associated with a service requester (e.g., the requester terminal 130).

User interface module 930 can be configured to generate, process, and/or present one or more user interfaces. For example, one or more user interfaces may be generated and/or presented to prompt a user to provide modifications to a request. As another example, one or more user interfaces may be generated and/or presented to provide navigation information, route information, etc. As still another example, one or more user interfaces may be generated and/or presented to provide cost information related to a request and/or a modification to the request.

The modules may be hardware circuits of all or part of the second user terminal. The modules may also be implemented as an application or set of instructions read and executed by the second user terminal. Further, the modules may be a combination of the hardware circuits and the application/instructions. For example, the modules may be the part of the second user terminal when the second user terminal is executing the application/set of instructions.

The modules in the second user terminal may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the I/O module 910 may be divided into an input unit that may receive the at least one modification and an output unit that may send the updated information.

It should be noted that the second user terminal illustrated in FIG. 9 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. In some embodiments, the second user terminal may further include a storage module (not shown in FIG. 9) configured to store data and/or instructions.

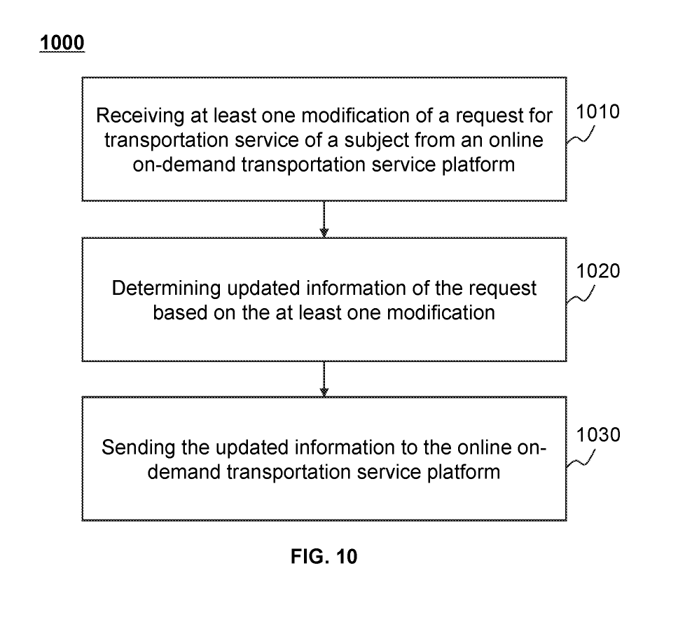

FIG. 10 is a flowchart illustrating an exemplary process of generating updated information by the second user terminal associated with a service provider according to some embodiments of the present disclosure. In some embodiments, the process 1000 may be implemented in the system 100 illustrated in FIG. 1. For example, the process 1000 may be stored in the storage 150 and/or the storage device (e.g., the ROM 230, the RAM 240, etc.) as a form of instructions, and invoked and/or executed by the provider terminal 140 (e.g., the processor 220 of the provider terminal 140, or one or more modules in the second user terminal illustrated in FIG. 9).

In step 1010, the I/O module 910 may receive at least one modification of a request for transportation service of a subject from an online on-demand transportation service platform (e.g., the server 110). In some embodiments, the first user terminal associated with a service requester (e.g., the requester terminal 130) may install an application for sending out a transportation service request. Through the application, the first user terminal may establish connection and communicate with the server 110. Through the application, the service requester may modify the pickup location of the request and/or the destination of the request and send the modified pickup location and/or the modified destination to the server 110. In some embodiments, the second user terminal may install an application for accepting a transportation service request. Through the application, the second user terminal may establish connection and communicate with the server 110 and receive the modified pickup location and/or the modified destination from the server 110.

In step 1020, the client-side service information updating module 920 may determine updated information of the request based on the at least one modification. In some embodiments, the method of determining the updated information by the second user terminal may be same as the method of determining the updated information by the processing engine 112 (e.g., the process 400-the process 800).

In step 1030, the I/O module 910 may send the updated information to the online on-demand transportation service platform. In some embodiments, after receiving the updated information from the second user terminal, the online on-demand transportation service platform may send the updated information to the first user terminal associated with the service requester (e.g., the requester terminal 130).

In some embodiments, the first user terminal may be and/or include any user terminal as described in connection with FIG. 1, such as a requester terminal 130 of FIG. 1. The first user terminal may include a requester I/O module and an interface module. The requester I/O module may be configured to send the at least one modification of the request for transportation service to the online on-demand transportation service platform and/or receive the updated information from the online on-demand transportation service platform. The interface module may be configured to present one or more user interfaces for the service requester to input the at least one modification.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
a bus;
at least one storage media electronically connected to the bus, comprising a set of instructions; and
logic circuits configured to communicate with the at least one storage media via the bus, wherein when executing the set of instructions, the logic circuits are directed to:
receive, from a first user terminal associated with a service requester, first electronic signals including at least one modification of a request for transportation service, wherein the at least one modification comprises at least one of a modified pickup-location or a modified destination;
identify a service provider associated with the request for transportation service;
generate updated information related to the request for transportation service based on the at least one modification of the request for transportation service, wherein the updated information related to the request for transportation service includes at least one of an updated route or an updated cost; and
send, to a second user terminal associated with the service provider, second electronic signals including the updated information related to the request for transportation service.

2. The system of claim 1, wherein to generate the updated information related to the request for transportation service the logic circuits are directed to:
determine a first location of the service provider; and
determine a first updated route based on the first location of the service provider and the modified pickup location, wherein the updated information related to the request for transportation service comprises the first updated route.

3. The system of claim 2, wherein to generate the updated information related to the request for transportation service the logic circuits are directed to:
determine an original pickup location of the request for transportation service;
determine a first distance between the original pickup location and the location of the service provider;
determine a second distance between the modified pickup location and the location of the service provider based on the first updated route;
determine a difference between the first distance and the second distance;
compare the difference with a threshold; and
determine a first updated cost based on the comparison, wherein the updated information related to the request for transportation service comprises the first updated cost.

4. The system of claim 1, wherein to generate the updated information related to the request for transportation service the logic circuits are directed to:
determine an original destination of the request for transportation service; and
determine a second updated route based on the modified pickup location and the original destination, wherein the updated information related to the request for transportation service comprises the second updated route.

5. The system of claim 4, wherein to generate the updated information related to the request for transportation service the logic circuits are directed to:
determine a third distance between the modified pickup location and the original destination based on the second updated route; and
determine a second updated cost based on the third distance, wherein the updated information related to the request for transportation service comprises the second updated cost.

6. The system of claim 1, wherein to generate the updated information related to the request for transportation service the logic circuits are directed to:
determine a third updated route based on the modified pickup location and the modified destination, wherein the updated information related to the request for transportation service comprises the third updated route.

7. The system of claim 6, wherein to generate the updated information related to the request for transportation service the logic circuits are directed to:
determine a fourth distance between the modified pickup location and the modified destination based on the third updated route; and
determine a third updated cost based on the fourth distance, wherein the updated information related to the request for transportation service comprises the third updated cost.

8. The system of claim 1, wherein to generate the updated information related to the request for transportation service the logic circuits are directed to:
generate a determination result by determining whether the service provider has picked up a subject related to the request for transportation service; and
generate the updated information related to the request for transportation service based on the determination result.

9. The system of claim 8, wherein to generate the updated information related to the request for transportation service based on the determination result the logic circuits are directed to:
determine a second location of the service provider; and
determine a fourth updated route based on the second location of the service provider and the modified destination, wherein the updated information related to the request for transportation service comprises the fourth updated route, wherein the determination results comprise a determination that the service provider has picked up the subject related to the request for transportation service.

10. The system of claim 9, wherein to generate the updated information related to the request for transportation service the logic circuits are directed to:
determine a fifth distance between the second location of the service provider and the modified destination based on the fourth updated route; and
determine a fourth updated cost based on the fifth distance, wherein the updated information related to the request for transportation service comprises the fourth updated cost.

11. The system of claim 8, wherein to generate the updated information related to the request for transportation service based on the determination result the logic circuits are directed to:
determine an original pickup location of the request for transportation service; and
determine a fifth updated route based on the original pickup location and the modified destination, wherein the updated information related to the request for transportation service comprises the fifth updated route, wherein the determination result comprises a determination that the service provider has not picked up the subject.

12. The system of claim 11, wherein to generate the updated information related to the request for transportation service the logic circuits are directed to:
determine a sixth distance between the original pickup location and the modified destination based on the fifth updated route; and
determine a fifth updated cost based on the sixth distance, wherein the updated information related to the request for transportation service comprises the fifth updated cost.

13. The system of claim 1, wherein to generate the updated information related to the request for transportation service the logic circuits are directed to:
determine timing information related to the at least one modification of the request for transportation service; and
determine a sixth updated cost based on the timing information, wherein the updated information related to the request for transportation service comprises the sixth updated cost.

14. The system of claim 1, wherein the updated information related to the request for transportation service comprises at least one of the modified destination or the modified pickup location.

15. A method, comprising:
receiving, from a first user terminal associated with a service requester, first electronic signals including at least one modification of a request for transportation service, wherein the at least one modification comprises at least one of a modified pickup-location or a modified destination;
identifying, by at least one processor, a service provider associated with the request for transportation service;
generating, by the at least one processor, updated information related to the request for transportation service based on the at least one modification of the request for transportation service, wherein the updated information related to the request for transportation service includes at least one of an updated route or an updated cost; and
sending, to a second user terminal associated with the service provider, second electronic signals including the updated information related to the request for transportation service.

16. The method of claim 15, wherein generating the updated information related to the request for transportation service comprises:
determining, by the at least one processor, a first location of the service provider; and
determining, by the at least one processor, a first updated route based on the first location of the service provider and the modified pickup location, wherein the updated information related to the request for transportation service comprises the first updated route.

17. The method of claim 16, wherein generating the updated information related to the request for transportation service comprises:
determining, by the at least one processor, an original pickup location of the request for transportation service;
determining, by the at least one processor, a first distance between the original pickup location and the location of the service provider;
determining, by the at least one processor, a second distance between the modified pickup location and the location of the service provider based on the first updated route;
determining, by the at least one processor, a difference between the first distance and the second distance;
comparing, by the at least one processor, the difference with a threshold; and
determining, by the at least one processor, a first updated cost based on the comparison, wherein the updated information related to the request for transportation service comprises the first updated cost.

18. The method of claim 15, wherein generating the updated information related to the request for transportation service comprises:
determining, by the at least one processor, an original destination of the request for transportation service; and
determining, by the at least one processor, a second updated route based on the modified pickup location and the original destination, wherein the updated information related to the request for transportation service comprises the second updated route.

19. The method of claim 18, wherein generating the updated information related to the request for transportation service comprises:
determining, by the at least one processor, a third distance between the modified pickup location and the original destination based on the second updated route; and
determining, by the at least one processor, a second updated cost based on the third distance, wherein the updated information related to the request for transportation service comprises the second updated cost.

20. A non-transitory computer-readable medium comprising executable instructions that, when executed by at least one processor, cause the at least one processor to effectuate a method comprising:
receiving, from a first user terminal associated with a service requester, first electronic signals including at least one modification of a request for transportation service of a subject, wherein the at least one modification comprises at least one of a modified pickup-location or a modified destination;
identifying a service provider associated with the request for transportation service;
generating updated information related to the request for transportation service based on the at least one modification of the request for transportation service, wherein the updated information related to the request for transportation service includes at least one of an updated route or an updated cost; and
sending, to a second user terminal associated with the service provider, second electronic signals including the updated information related to the request for transportation service.
